(19) United States
(12) Patent Application Publication
(10) Pub. No.: US 2021/0259071 A1
(43) Pub. Date: Aug. 19, 2021

(54) SELF-IDENTIFYING LIGHT FIXTURE

(71) Applicant: Universal Lighting Technologies Inc., Nashville, TN (US)

(72) Inventors: John CAVACUITI, Burnaby (CA); Masaaki IKEHARA, Burnaby (CA); Travis BERRY, Madison, AL (US); Wei XIONG, Madison, AL (US); Hideki AOYAMA, Osaka (JP)

(21) Appl. No.: 16/795,322

(22) Filed: Feb. 19, 2020

(51) Int. Cl. H05B 45/10; H05B 47/155; G06K 9/46

(52) U.S. Cl. CPC H05B 45/10; H05B 47/19; G06K 9/4661; H05B 47/155

(57) ABSTRACT

A technique for uniquely identifying a light fixture for use in a positioning system may include providing a first set of LED and a second set of LED in the light fixture, and controlling the first set of LED differently from the second set of LED such that a camera having the light fixture within its field of view captures images in which the first set of LED appears to emit light and the second set of LED appears to emit no light to form a detectable pattern uniquely associated with the light fixture.

### BACKGROUND

Global Positioning Systems (GPS) are well-known and are used in numerous applications for indicating location of people and devices. However, GPS does not work well indoors because satellite signals on which GPS systems rely are attenuated and scattered by roofs, walls and other objects when passing through construction materials, making it unsuitable for indoor environments.

Indoor positioning systems (IPS) are a better alternative to GPS positioning for indoor environments. IPS involves the use of networks of devices and algorithms to locate mobile devices within buildings. Indoor positioning is important for applications that utilize a user's location to provide content relevant to that location.

Various techniques including techniques based on received signal strength indication (RSSI) from Wi-Fi and Bluetooth wireless access points have been explored for IPS applications. However, complex indoor environments tend to limit the accuracy of positioning systems based on RSSI. Ultrasonic techniques that transmit acoustic waves to microphones have also been attempted for indoor positioning, but with mixed results.

Another IPS technology involves the installation of beacons throughout indoor environments. The beacons communicate with mobile devices via Wi-Fi, Bluetooth, Near Field Communication (NFC), RFID, etc. for the beacons to transmit location to the mobile devices. Beacon-based position may be expensive because of the need to install and maintain dedicated devices throughout the environment.

Yet another IPS technology is pedestrian dead reckoning (PDR). PDR involves using existing functions of mobile devices such as accelerometers, motion sensors, etc. to sense how (speed, direction, etc.) a person is walking. It estimates the position while calculating how the person is moving from a certain location. PDR must be used in combination with some of the other technologies listed above because an absolute location must usually be established (e.g., by GPS or beacon) before PDR can begins to keep track of how far and in what direction the person has moved.

Light-based indoor positioning techniques use light signals, either visible or infrared, and can be used to accurately locate mobile devices indoors. This technology is known as visible light communication or VLC. Conventionally, VLC involved very accurate, high frequency modulating of all LED in a fixture to send digital serial messages that may be captured by image sensors and reconstructed and demodulated thereafter. These techniques tend to be more accurate than RSSI and ultrasonic approaches. However, these techniques have been hampered by issues of complexity, relatively high costs of implementation, and obsolescence.

### BRIEF SUMMARY OF THE INVENTION

In accordance with one aspect of the invention, the present disclosure discloses self-identifying light fixtures for a visible light communication-based positioning system. The light fixtures switch some of their light-emitting components (e.g., LED) differently from other of their light-emitting components to create codes or patterns that are not noticeable to naked human eyes but are capturable by image sensors in modern mobile devices. Each code or pattern may be uniquely associated with a light fixture to uniquely identify the light fixture.

The codes or patterns are generally fixed to the corresponding light fixture and not continuously changing. The codes or patterns are not ongoing serial messages such as those seen in conventional VLC, but they instead behave much like a bar code that uniquely and fixedly identifies the corresponding light fixture. Identifying the light fixture allows for knowing the location of the light fixture. Knowing the location of the light fixture allows correlation of the location of the light fixture to the location of the mobile device.

These and other advantages of the invention will become apparent when viewed in light of the accompanying drawings, examples, and detailed description.

### BRIEF DESCRIPTION OF THE DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates a schematic diagram of an exemplary light fixture in communication with a mobile device.

FIG. 2 illustrates a schematic diagram of an exemplary novel VLC technique.

FIG. 3 illustrates a schematic diagram of another exemplary novel VLC technique.

FIGS. 4A and 4B illustrate exemplary switching diagrams for the novel VLC techniques of FIGS. 2 and 3, respectively.

FIGS. 5A and 5B illustrate images of captured linear LED fixtures exhibiting the identification techniques of FIGS. 2 and 3, respectively.

FIG. 6 illustrates a schematic diagram of another exemplary novel VLC technique.

FIG. 7 illustrates a schematic diagram of a positioning system including a mobile device receiving identification information from multiple LED light fixtures.

FIG. 8A illustrates a block diagram of an exemplary mobile device for use in a positioning system.

FIG. 8B illustrates a block diagram of an exemplary light source for use in a positioning system.

FIG. 9 illustrates a block diagram of an exemplary server for use in a positioning system.

FIG. 10 illustrates a flow diagram for an exemplary method for a mobile device to uniquely identify a light fixture in a positioning system.

FIG. 11 illustrates a flow diagram for an exemplary method for a light fixture to uniquely identify itself in a positioning system.

### DETAILED DESCRIPTION

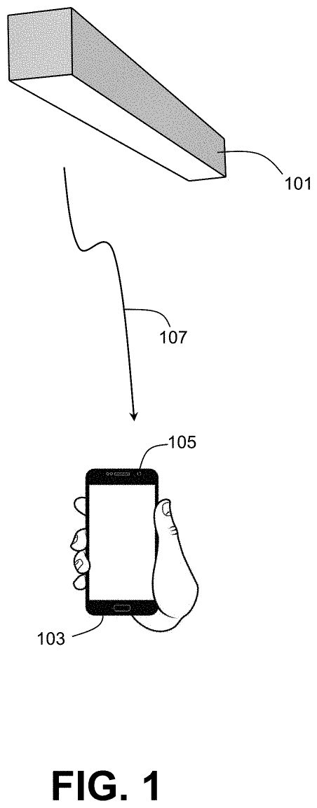

FIG. 1 illustrates a schematic diagram of an exemplary light fixture 101 in communication with a mobile device 103. The mobile device 103 may include an image sensor or camera 105 that receives light 107 from the light fixture 101 and, as explained in detail below, may thereby receive a fixed code or pattern uniquely associated with the light fixture 101 to identify the light fixture 101.

Mobile device 103 may be a mobile phone, a tablet, a portable laptop computer, or a dedicated positioning device. The mobile device 103 includes the camera 105 which is used to receive the incoming light signals 107 and thereby receive information from the light fixture 101.

The light fixture 101 may be, for example, an LED light fixture. Alternatively, the light fixture 101 may use incandescent or fluorescent technologies. The light fixture 101 may be any lighting source used for general purpose, spot illumination, or backlighting, white light or even infrared light fixture. The light fixture 101 may have many different form factors including Edison screw in, tube style, large and small object backlighting, or accent lighting spots and strips.

LED, for example, are electronic devices that may be used in lighting applications and may also be rapidly switched on and off to send signals at frequencies at which the human eye cannot detect the switching. For this reason, LED have been used to send digital data through visible light itself. This technology is known as visible light communication or VLC. Conventionally, VLC involved very accurate, high frequency modulating of all LED in a fixture to send digital information that may be captured by image sensors and demodulated thereafter. The modulation may take place by amplitude-shift keying (ASK), frequency-shift keying (FSK), or, perhaps more commonly, by digital pulse recognition (DPR) which exploits the rolling shutter mechanism of a complementary metal-oxide-semiconductor (CMOS) image sensors to recover digital data from the optically encoded signal. These modulating techniques are complex, costly to implement, and may become outdated with the introduction of more sophisticated image sensors in mobile devices. The systems and methods described herein address some of the shortcomings of conventional VLC.

Typical cameras in modern mobile phones have default frame rates between fifteen and sixty frames per second (fps) and shutter speeds ranging from 1/8000s to ⅓s. Frame rates and shutter speeds are directly related to whether the camera 105 can detect switching optical signals. The camera sensor can capture a number of successive image frames each of a certain length that can later be analyzed to determine information the light fixture 101 may be providing through light.

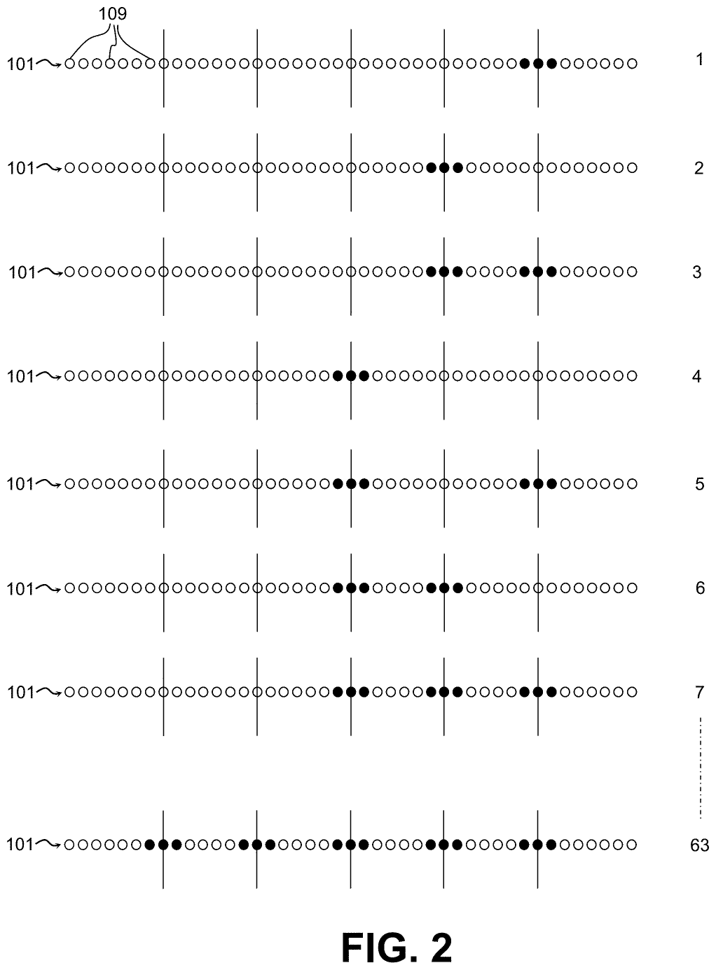

FIG. 2 illustrates a schematic diagram of an exemplary embodiment of a novel VLC technique that takes advantage of these characteristics of typical cameras in modern mobile phones. The technique is disclosed herein in the context of a linear light fixture (i.e., the LED 109 are disposed on a line adjacent each other) for ease of explanation, but these principles are equally applicable in other light fixture contexts. In this very simple example, the light fixture 101 includes 43 LED 109 represented by circles. Empty circles represent LED 109 that are on (appear to emit light) and filled circles represent LED 109 that are off (appear not to emit light), as captured by the camera 105. Thus, empty circles represent a first set of LED that appear to be on as captured by the camera 105 and filled circles represent a second set of LED that appear to be off as captured by the camera 105.

From the 43 LED 109, five potential symbol slots or bits have been identified, each including three LED 109, and are schematically marked with a center vertical line. To transmit the number 1, for example, the light fixture 101 of FIG. 2 switches the first set of LED (shown as being on) at a different rate from the second set of LED (shown as being off). The frequency at which the first set of LED shown as being on is switched is chosen to be high enough such that the camera 105 cannot capture the first set of LED in the off state. This frequency is referred to herein as the non-capture threshold frequency. In one embodiment, the first set of LED is simply on all of the time, not switched, such that the camera 105 cannot capture the first set of LED in the off state. The frequency at which the second set of LED shown as being off is switched is chosen to be low enough (lower than the non-capture threshold frequency) such that the camera 105 captures the second set of LED in the off state, at least within a relatively small number of frames. Similarly, to transmit the number 2, the light fixture 101 switches the first set of LED shown as being on at a different rate from the second set of LED shown as being off so that the camera 105 may capture the pattern, and so on. In one embodiment, the light fixture 101 simply turns on the first set of LED and switches the second set of LED on and off so that the camera 105 may capture the pattern.

In the example of FIG. 2, LED 109 disposed at ends of the linear light fixture 101 are in the first set of LED (which appear to be on as captured by the camera 105) so that detectable patterns have a fixed length. LED 109 in the second set of LED (which appear to be off as captured by the camera 105) are disposed therebetween so that they are always inside the pattern frame at not at ends where they would be undetectable. Also, in the example of FIG. 2, slot symbols or bits each includes three LED with four LED therebetween and six LED at the ends of the pattern. But slot symbols or bits may include less or more than three LED with less or more than four LED therebetween and less or more than six LED at the ends of the pattern. The exact structure of the pattern frame may be chosen so that the pattern frame has a detectable length and so that there is sufficient contrast between the symbol slots or bits and the rest of the pattern as captured by the camera 105.

The example of FIG. 2 is limited to 63 different codes or patterns. The case in which all LED are on is not considered a code or pattern in this example because it would be indistinguishable from a regular fixture or from a frame in which the camera 105 does not capture the code or pattern. Moreover, the actual number of detectable patterns for this example may be limited to 31 because of symmetry of the patterns and the inability, in this example, of detecting the direction at which the camera 105 captures light from the fixture 101. This example is offered for ease of explanation and other, more robust approaches are available.

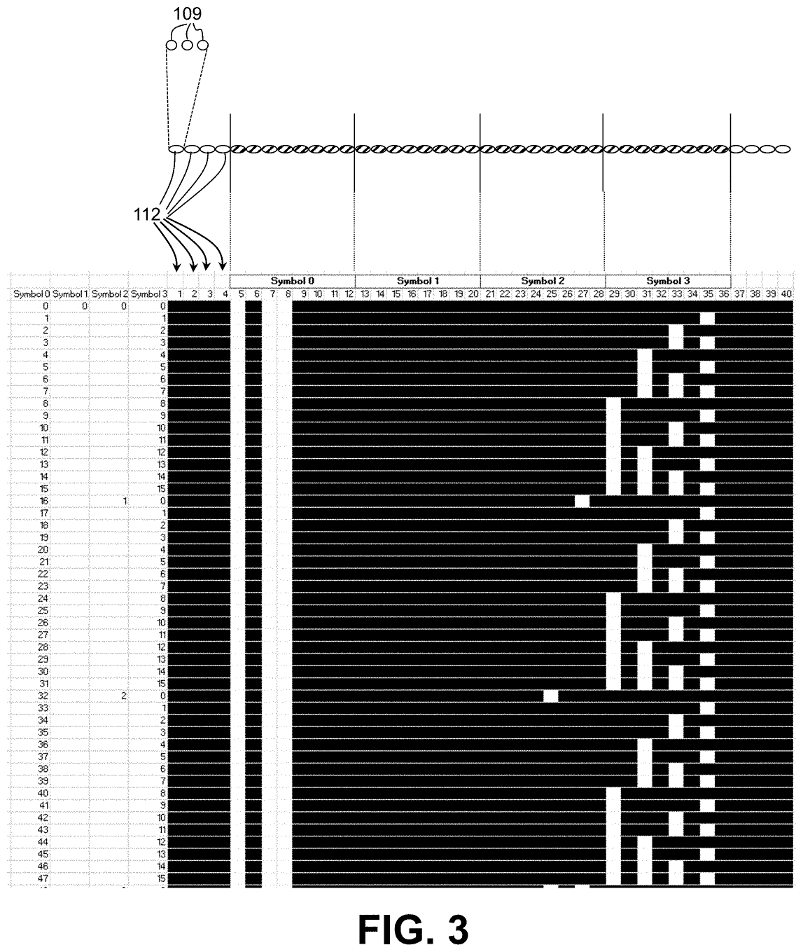

FIG. 3 illustrates a schematic diagram of another exemplary embodiment of the novel VLC technique. In this example, the light fixture 101 includes 120 LED 109. Each three LED are grouped into a slot 112 represented by an oval. Therefore, there are 40 slots 112 in this example. In the table of FIG. 3, slots 112 that are to appear on as captured by camera 105 are represented as filled or black squares and slots that are to appear off as captured by camera 105 are represented as empty or white squares.

The four slots at the left end (1-4) and the four slots at the right end (37-40) of the linear light fixture 101 are in the first set of LED (which appear to be on as captured by the camera 105) so that detectable patterns have a fixed length. LED disposed therebetween may be used for fixture identification. Symbol 0 may be used for direction identification so that, when interpreting the captured pattern, the direction in which the pattern is to be read is clear. That leaves three symbols (1, 2, and 3) of eight slots each for fixture identification. If four of the eight slots are switched on and off (as shown on the table of FIG. 3), this is the equivalent of 12 bits or 4096 distinct codes or patterns.

Again, the switching frequency of the first set of LED (which appear to be on as captured by the camera 105) is chosen to be high enough such that the camera 105 cannot capture the first set of LED in the off state, the non-capture threshold frequency. In one embodiment, the first set of LED (which appear to be on as captured by the camera 105) are simply turn on indefinitely such that the camera 105 cannot capture the first set of LED in the off state. The frequency at which the second set of LED shown as being off is switched is chosen to be low enough (lower than the non-capture threshold frequency) such that the camera 105 may capture the second set of LED in the off state, at least within a relatively small number of frames.

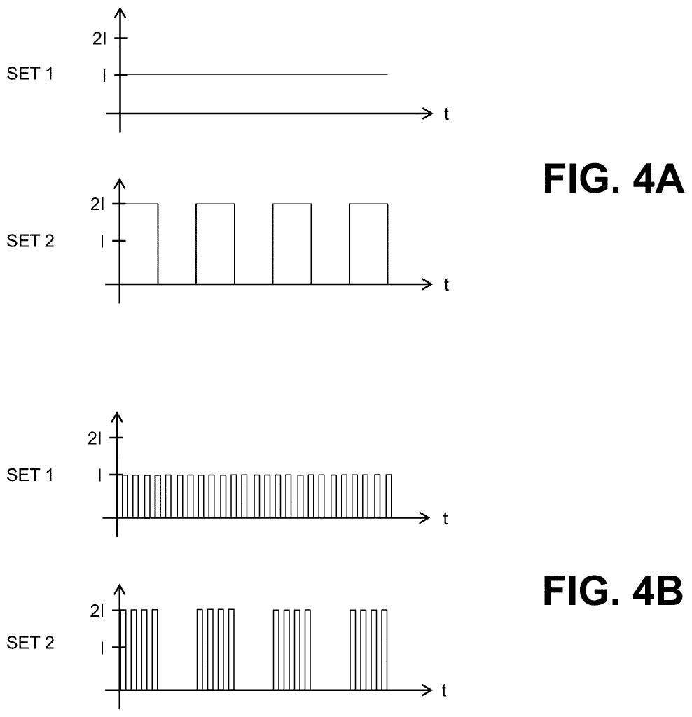

FIGS. 4A and 4B illustrate exemplary switching diagrams for the novel VLC techniques of FIGS. 2 and 3. To take advantage of specific characteristics (e.g., default frame rates and shutter speeds) of typical cameras in modern mobile phones, the fixture 101 controls the first set of LED SET1 differently from the second set of LED SET2 such that a camera 105 having the light fixture 101 within its field of view captures images in which the first set of LED SET1 appears to emit light and the second set of LED SET2 appears to emit no light to form a detectable pattern uniquely associated with the light fixture 101.

In the example of FIG. 4A, the light fixture 101 turns on the first set of LED SET1 indefinitely at a constant current I. Simultaneously, the fixture 101 switches the second set of LED SET2 on at a constant current 2I for half the time and off for half the time. Notice that, in this example, the instantaneous current applied to the second set of LED SET2 is double that applied to the first set of LED SET1 to compensate for the off time. Therefore, the first set of LED SET1 and the second set of LED SET2 would appear to the human eye as emitting the same amount of light.

The switching frequency of the second set of LED SET2 is chosen with two main criteria in mind: flicker and proper detection of the code or pattern. Regarding flicker, most humans cannot see flicker above 60 Hz, but in rare instances can perceive flicker at frequencies as high as 100 Hz to 110 Hz. To address flicker, the fixture 101 may switch the second set of LED SET2 at a frequency higher than 110 Hz. This frequency is referred to herein as the flicker threshold frequency. Regarding proper detection of the code or pattern, the chosen switching frequency must be low enough for the camera 105 to capture the off state of the second set of LED SET2 within a small number of frames, lower than the non-capture threshold frequency. In one embodiment, the fixture 101 switches the second set of LED SET2 at 125 Hz, which avoids humanly detectable flicker but can be detected by a typical mobile phone camera operating at 30 fps frame rate and 1/60 sec shutter speed within 4 frames. In most embodiments, switching frequencies between 110 Hz and 200 Hz would accomplish these goals.

In the example of FIG. 4B, the light fixture 101 switches the first set of LED SET1 and the second set of LED SET2. The light fixture 101 may switch the LED for dimming, increase longevity, decrease power consumption, etc. But even in this case it is possible to capture the identification code or pattern because the light fixture 101 switches the first set of LED SET1 differently from the second set of LED SET2. The switching frequency of the first set of LED SET1 is chosen with two main criteria in mind: to avoid flicker and to ensure proper detection of the code or pattern.

To address flicker, the fixture 101 may switch the first set of LED SET at a frequency higher than 110 Hz, the flicker threshold frequency. However, to ensure proper detection of the code or pattern, the fixture 101 must switch the first set of LED SET1 at much higher frequencies because, in this embodiment, the goal is to ensure that the camera 105, set to predetermined frame rates and shutter speeds, cannot capture images of the first set of LED SET1 in the off state. Thus, the switching frequency for the first set of LED SET1 may be set to frequencies significantly above 110 Hz to be above the non-capture threshold frequency. In one embodiment, the switching frequency for the first set of LED SET1 may be set to 1 kHz, 10 kHz, 100 kHz, etc. In some cases, dimming applications should have sufficiently high switching frequencies of 25 kHz or above such that even high frame rate and high shutter speed cameras cannot detect the first set of LED SET1 in the off state.

The second set of LED SET2 may be similarly switched at relatively high frequencies for dimming, increase longevity, decrease power consumption, etc. However, the second set of LED SET2 may simultaneously be switched for proper detection of the code or pattern. Notice in FIG. 4B that the second set of LED SET2 is switched at two different frequencies: the relatively high dimming frequency and the relatively low capture switching frequency. The chosen capture switching frequency must be low enough for the camera 105 to capture the off state of the second set of LED SET2 within a small number of frames, below the non-capture threshold frequency. In one embodiment, the fixture 101 switches the second set of LED SET2 at 125 Hz, which can be detected by a typical mobile phone camera operating at 30 fps frame rate and 1/60 sec shutter speed within 4 frames. In most embodiments, switching frequencies between 110 Hz and 200 Hz would accomplish these goals.

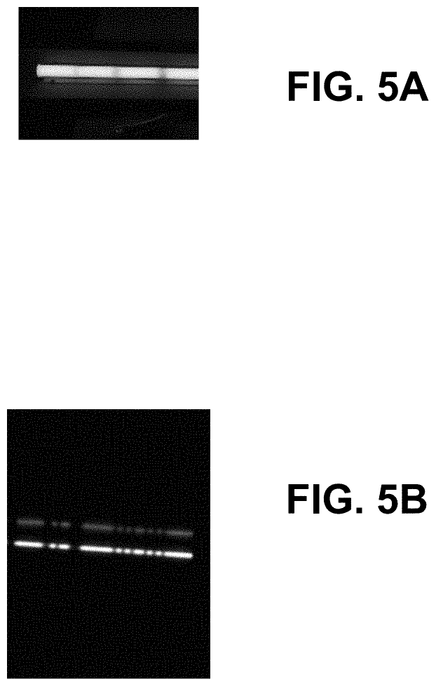

FIGS. 5A and 5B illustrate images of captured linear LED fixtures exhibiting the identification techniques described above. Notice the identifiable dark bands corresponding to the second set of LED captured in the off state. FIG. 5A corresponds to the embodiment of FIG. 1 while FIG. 5B corresponds to the embodiment of FIG. 2.

At least theoretically, the techniques described above should achieve a) effective transmission and detection of the code or pattern and b) uniform light distribution as perceived by the human eye. However, in practical applications, switching the first set of LED differently from the second set of LED may lead to non-uniform light distribution as perceived by the human eye. For example, light from the second set of LED may appear darker or not as intense compared to light from the first set of LED. Moreover, addressing this potential issue merely by controlling power supply as described in FIGS. 4A and 4B may be difficult. To further address this concern, in one embodiment, LED may be sequentially swapped from the first set of LED to the second set of LED.

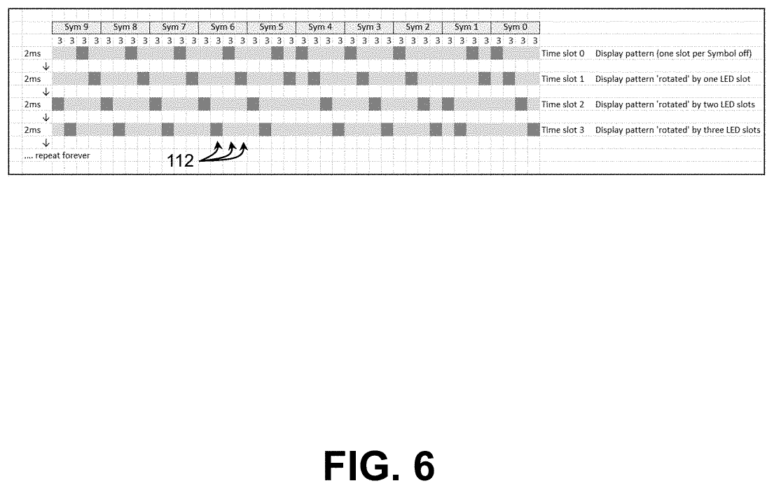

FIG. 6 illustrates a schematic diagram of another exemplary embodiment of the novel VLC technique. In the embodiment of FIG. 6, LED are swapped from the first set of LED to the second set of LED, effectively rotating through a symbol the LED that would appear as off as captured by camera 105. In this example, the light fixture 101 includes 120 LED 109. Each three LED are grouped into a slot 112 represented by a square. Therefore, there are 40 slots 112 in this example. The slots are divided into ten sections or symbols (Sym 0 to Sym 9), each symbol having four slots or twelve LED. Slots 112 that are to appear on as captured by camera 105 (i.e., the first set of LED) are represented as light grey squares and slots that are to appear off as captured by camera 105 (i.e., the second set of LED) are represented as dark grey squares.

At time 0 (Time slot 0), a pattern is presented. In this example, the pattern presented a time 0 has one slot 112 per symbol that appears to be off as captured by the camera 105 (i.e., one slot of LED in the second set of LED). From there the slot 112 that appears off is rotated within the symbol. Therefore, at time 1 (Time slot 1), the slot 112 per symbol that appeared to be off at time 0 has now been shifted right one slot within its symbol. At time 2 (Time slot 2), the slot 112 per symbol that appeared to be off at time 0 has now been shifted right two slots within its symbol. At time 3 (Time slot 3), the slot 112 per symbol that appeared to be off at time 0 has now been shifted right three slots within its symbol. At time 4 (not shown), the pattern may be presented as at time 0 and so on. This rotation of the slot or the LED that would appear as off as captured by camera 105 may continue indefinitely. Time slots 0-3 may correspond to, for example, 2 ms time periods. This technique results in better light distribution along the light fixture.

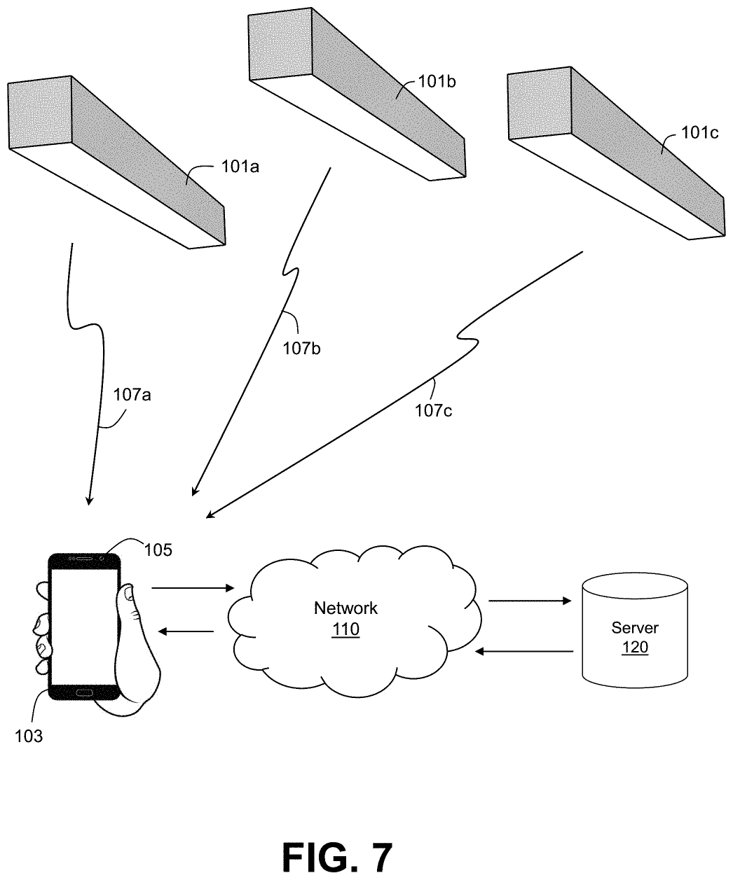

FIG. 7 illustrates a schematic diagram of a positioning system utilizing the techniques described herein. In one embodiment, the mobile device 103 transmits captured images through a network 110 to a server 120. The server 120 may then analyze the captured images to identify one or more light fixtures 101 and from that information calculate positioning information of the mobile device 103. In a light-based positioning system, the physical locations of light fixtures 101 can be used to approximate the relative position of a mobile device 103. In one embodiment, the mobile device 103 can use information to determine its own position. The mobile device 103 can access data containing information about where the light fixtures 101 are physically located to determine its own position. This data source can be stored locally, or in the case where the mobile device 103 has a network connection, the data source could be stored in the server 120. For cases where a network connection is not available, before entering an indoor space the mobile device 103 could optionally download the information used to locate itself indoors, instead of relying on the server 120.

The mobile device 103 or the server 120 may interpret the received images using, for example, computer vision or machine vision, and then look up the interpreted codes or patterns on a table to correlate them to corresponding light fixtures 101 or to locations corresponding to the light fixtures. In one embodiment, the mobile device 103 or the server 120 may have access to a database including stored images of all potential codes or patterns. By comparing the stored images to the images captured by the camera 105, the mobile device 103 or the server 120 may identify the specific light fixture 101. Based on that information, the mobile device 103 or the server 120 may then look up a location corresponding to the specific light fixture 101. The location data may correspond to indoor coordinates which match the code or pattern.

In practice, locations in which positioning may be necessary would typically include several light sources. Therefore, the mobile device 103 receives multiple light signals at once. FIG. 7 illustrates a schematic diagram of an exemplary mobile device 103 receiving identification information 107a-c from multiple LED light fixtures 101a-101c. Each light fixture may transmit its own code or pattern. Because the camera 105 can capture images in which light from each of the LED light fixtures 101a-101c is distinguishable from each other, deciphering the code or pattern and thereby identifying the corresponding light fixture is possible.

For the mobile device 103 equipped with the image sensor or camera 105, when multiple LED light fixtures 101a-c appear in the camera's field of view, the light fixtures 101a-c appear brighter relative to the other pixels on the image. Thresholds can then be applied to the image to isolate the light fixtures 101a-c within the image. For example, pixel regions above the threshold may be set to the highest possible pixel value, and the pixel regions below the threshold may be set to the minimum possible pixel value. This allows for additional image processing to be performed on the isolated light fixtures 101a-c. The end result is a binary image containing white continuous “blobs” where LED light fixtures 101a-c are detected and dark elsewhere where the fixtures are not detected. See examples in FIGS. 5A and 5B.

A blob detection algorithm can then be used to find separate LED light fixtures 101a-c. Three separate LED blobs may be used to resolve the 3-D position of a mobile device 103. Each LED blob is a region of interest and simultaneously transmits its unique code or pattern as described above. For the purposes of deciphering the code or pattern, each region of interest may be processed independently of other regions of interest and is considered to be uniquely identifiable. Once the regions of interest are established, a detection algorithm may capture multiple image frames for each region of interest in order to decipher the code or pattern contained in each blob. Each frame may be split into separate regions of interest, based on the detection of light fixtures.

The mobile device 103 or the server 120 may then look up the interpreted codes or patterns on a table to correlate them to corresponding light fixtures 101 or to locations corresponding to the light fixtures. In one embodiment, the mobile device 103 or the server 120 may have access to a database including stored images of all potential codes or patterns. By comparing the stored images to the images captured by the camera 105, the mobile device 103 or the server 120 may identify the specific light fixture 101. Based on that information, the mobile device 103 or the server 120 may then look up a location corresponding to the specific light fixture 101. The location data may correspond to indoor coordinates which match the code or pattern.

When three or more sources of light are in view of the camera 105 as in FIG. 7, relative indoor position can be determined in three dimensions. In fact, position accuracy increases from when analysis is done with one light fixture to when analysis is done with three light fixtures. With the relative positions of lights 101a-101c known, the mobile device 103 and/or the server 120 can use photogrammetry to calculate the position of the mobile device 103, relative to the light fixtures 101.

In the context of locating mobile devices using light fixtures, photogrammetry utilizes the corresponding positions of the LED light fixtures 101 in 3-D space to determine the relative position of the mobile device 103. When three unique sources of light are seen by the camera 105 on the mobile device 103, three unique coordinates can be created from the various unique combinations of 101a-101c and their relative positions in space can be determined.

The above are simplified explanations of the process of, once the light fixtures have been identified, determining the location of the mobile device 103. The precise details of, once the light fixture has been identified, determining the location of the mobile device 103, which device (e.g., mobile device 103 or server 120) performs which specific function, etc. may vary depending on the specific application.

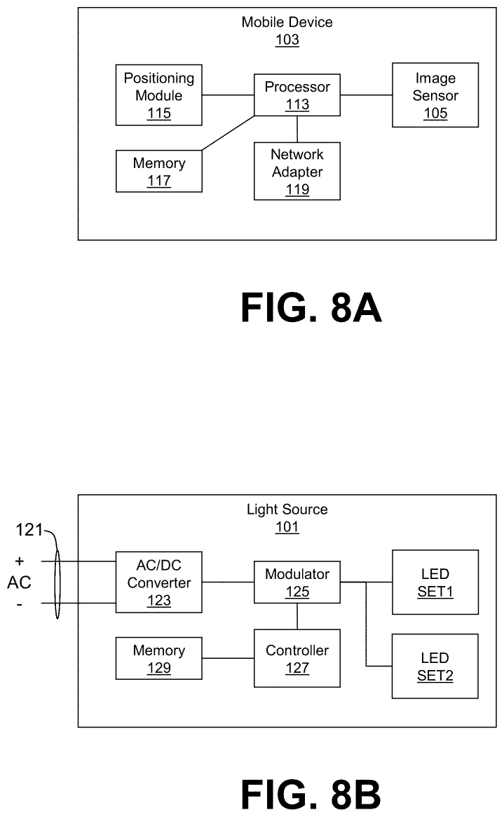

FIG. 8A illustrates a block diagram of an exemplary mobile device 103. The mobile device 103 may include a processor 113, a positioning module 115, memory 117, an image sensor or camera 105 to capture and analyze light received from light fixtures 101, and a network adapter 119 to send and receive information. The mobile device can analyze the successive image frames captured by the camera 105 by using the positioning module 115. The module 115 can be logic implemented in any combination of hardware and software. The logic can be stored in memory 117 and run by the processor 113 to analyze successive images to determine codes or patterns encoded in the light of one or more light fixtures 101. The module 115 can be an application that runs on the mobile device 103.

Image sensor 105 may be a typical sensor found in modern mobile devices. The image sensor 105 converts the incoming optical signal into an electronic signal. Many modern mobile devices contain complementary metal-oxide-semiconductor (CMOS) image sensors, however some still use charge-coupled devices (CCD).

The processor 113 may be a generic CPU found in modern mobile devices. The CPU 113 processes received information and sends relevant information to the network adapter 119. Additionally, the CPU 113 reads and writes information to memory 117. The CPU 113 can use any standard computer architecture. Common architectures for microcontroller devices include ARM and x86.

The network adapter 119 is the networking interface that allows the mobile device 103 to connect to cellular and Wi-Fi networks. The mobile device 103 uses the network connection to access a correlation information between detected codes or patterns and light fixtures and/or their locations. data source containing light ID codes 701 with their corresponding location data 702. Obtaining this information can be accomplished without a data connection by storing location data locally to the mobile device's 103 memory 117. The network adapter 119, however, allows for greater flexibility and decreases the resources needed locally at the mobile device 103.

The network 110 (shown on FIG. 6) corresponds to a data network which can be accessed by mobile devices 103a-103b via their embedded network adapters 119. The network 110 can consist of a wired or wireless local area network (LAN), with a method to access a larger wide area network (WAN), or a cellular data network (Edge, 3G, 4G, LTS, CDMA, GSM, LTE, etc.). The network connection provides the ability for the mobile devices 103a-103b to send and receive information from additional sources, whether locally or remotely.

FIG. 8B illustrates a block diagram of an exemplary light source 101. LED light source 101 may include an AC electrical connection 121 to connect to an external power source, an AC/DC converter 123 to convert the AC to DC, a modulator 125 which switches the LED on and off, the first set of LED SET1, the second set of LED SET2, and a controller 127 which controls the rate at which the LED are switched. Modulator 125 switches the first set of LED and the second set of LED of the LED light source 101 on and off differently as described above to optically send light signals. In one embodiment, the modulator 125 includes two modulators to switch the first set of LED and the second set of LED on and off differently as described above. The modulator 125 may include transistors (e.g., MOSFET) controlled by the controller 127. The light fixture may include memory storage 129 to store the identification code or pattern that the light fixture 101 transmits. Examples of possible memory types include programmable read only memory (PROM), electrically erasable programmable read only memory (EEPROM), or Flash.

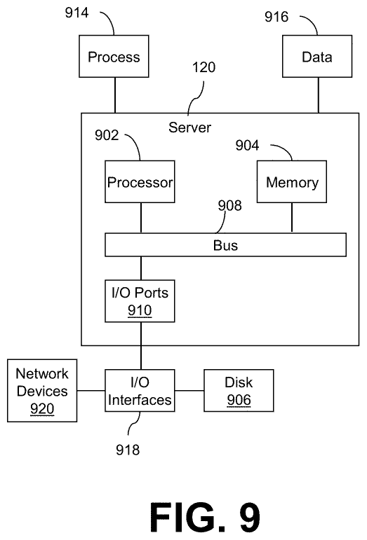

FIG. 9 illustrates a block diagram of an exemplary server 120 for use in a positioning system. The server 120 includes a processor 902, a memory 904, and I/O Ports 910 operably connected by a bus 908. The processor 902 can be a variety of various processors including dual microprocessor and other multi-processor architectures. The memory 904 can include volatile memory or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 906 may be operably connected to the server 120 via, for example, an I/O Interfaces (e.g., card, device) 918 and an I/O Ports 910. The disk 906 can include, but is not limited to, devices like a magnetic disk drive, a solid-state disk drive, a floppy disk drive, a tape drive, a Zip drive, a flash memory card, or a memory stick. Furthermore, the disk 906 can include optical drives like a CD-ROM, a CD recordable drive (CD-R drive), a CD rewriteable drive (CD-RW drive), or a digital video ROM drive (DVD ROM). The memory 904 can store processes 914 or data 916, for example. The disk 906 or memory 904 can store an operating system that controls and allocates resources of the server 120.

The bus 908 can be a single internal bus interconnect architecture or other bus or mesh architectures. While a single bus is illustrated, it is to be appreciated that server 120 may communicate with various devices, logics, and peripherals using other busses that are not illustrated (e.g., PCIE, SATA, Infiniband, 1394, USB, Ethernet). The bus 908 can be of a variety of types including, but not limited to, a memory bus or memory controller, a peripheral bus or external bus, a crossbar switch, or a local bus. The local bus can be of varieties including, but not limited to, an industrial standard architecture (ISA) bus, a microchannel architecture (MCA) bus, an extended ISA (EISA) bus, a peripheral component interconnect (PCI) bus, a universal serial (USB) bus, and a small computer systems interface (SCSI) bus.

The server 120 may interact with input/output devices via I/O Interfaces 918 and I/O Ports 910. Input/output devices can include, but are not limited to, a keyboard, a microphone, a pointing and selection device, cameras, video cards, displays, disk 906, network devices 920, and the like. The I/O Ports 910 can include but are not limited to, serial ports, parallel ports, and USB ports.

The server 120 can operate in a network environment and thus may be connected to network devices 920 via the I/O Interfaces 918, or the I/O Ports 910. Through the network devices 920, the server 120 may interact with a network. Through the network, the server 120 may be logically connected to remote computers. The networks with which the server 120 may interact include, but are not limited to, a local area network (LAN), a wide area network (WAN), and other networks. The network devices 920 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), Zigbee (IEEE 802.15.4) and the like. Similarly, the network devices 920 can connect to WAN technologies including, but not limited to, point to point links, circuit switching networks like integrated services digital networks (ISDN), packet switching networks, and digital subscriber lines (DSL). While individual network types are described, it is to be appreciated that communications via, over, or through a network may include combinations and mixtures of communications.

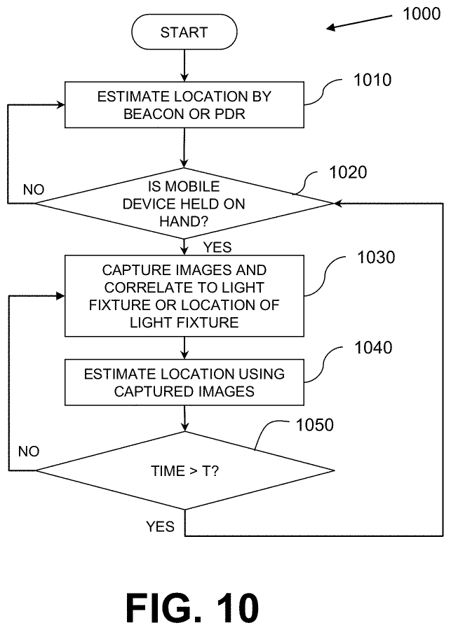

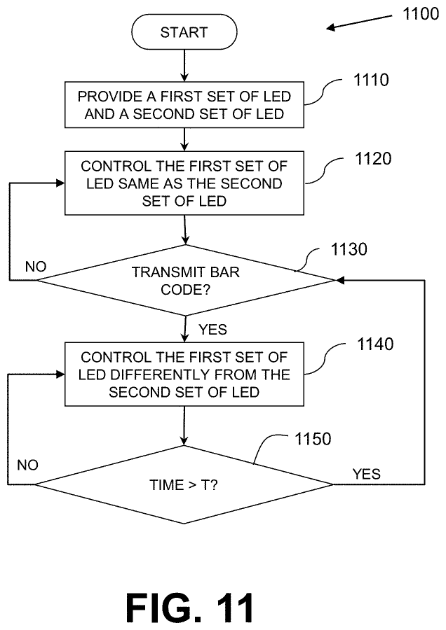

Exemplary methods may be better appreciated with reference to the flow diagrams of FIGS. 10 and 11. While for purposes of simplicity of explanation, the illustrated methodologies are shown and described as a series of blocks, it is to be appreciated that the methodologies are not limited by the order of the blocks, as some blocks can occur in different orders or concurrently with other blocks from that shown and described. Moreover, less than all the illustrated blocks may be required to implement an exemplary methodology. Furthermore, additional methodologies, alternative methodologies, or both can employ additional blocks, not illustrated.

In the flow diagrams, blocks denote “processing blocks” that may be implemented with logic. The processing blocks may represent a method step or an apparatus element for performing the method step. The flow diagrams do not depict syntax for any particular programming language, methodology, or style (e.g., procedural, object-oriented). Rather, the flow diagrams illustrate functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various programming approaches like machine language, procedural, object oriented or artificial intelligence techniques.

FIG. 10 illustrates a flow diagram for an exemplary method 1000 for a mobile device to uniquely identify a light fixture for use in a positioning system. The system may be a hybrid system that uses visible light communication as described above when a mobile device's camera is available but, otherwise, uses conventional beacon or PDR based positioning as in 1010. At 1020, the method inquires whether the mobile device is held on a user's hand and is thus available for visible light communication. If no, the method returns to 1010 and continues use of beacon or PDR. If the mobile device is available, at 1030, the mobile device begins to capture images and either transmits the images to a server to be analyzed and correlated to light fixtures as described above or the mobile device itself may analyze and correlate the captured images to light fixtures. At 1040, based on the location of any identified light fixtures in the captured images, the method estimates the location of the mobile device. At 1050, the method goes back to 1020 to verify that the mobile device continuous to be held by the user's hand.

FIG. 11 illustrates a flow diagram for an exemplary method 1100 for a light fixture to uniquely identify itself in a positioning system. At 1110, the light fixture includes a first set of LED and a second set of LED that are independently controllable. At 1120, the light fixture may control the first set of LED the same as the second set of LED prior to transmitting any codes or patterns. At 1130, if there is a code or pattern in memory to be transmitted, the method moves to 1140 to control the first set of LED differently from the second set of LED to effectively transmit the code or pattern, as described above. At 1150, the method may go back to 1130 to verify that the pattern or code to be transmitted.

While the figures illustrate various actions occurring in serial, it is to be appreciated that various actions illustrated could occur substantially in parallel, and while actions may be shown occurring in parallel, it is to be appreciated that these actions could occur substantially in series. While a number of processes are described in relation to the illustrated methods, it is to be appreciated that a greater or lesser number of processes could be employed and that lightweight processes, regular processes, threads, and other approaches could be employed. It is to be appreciated that other exemplary methods may, in some cases, also include actions that occur substantially in parallel. The illustrated exemplary methods and other embodiments may operate in real-time, faster than real-time in a software or hardware or hybrid software/hardware implementation, or slower than real time in a software or hardware or hybrid software/hardware implementation.

While example systems, methods, and so on, have been illustrated by describing examples, and while the examples have been described in considerable detail, it is not the intention to restrict or in any way limit the scope of the appended claims to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, and illustrative examples shown or described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

### Definitions

The following includes definitions of selected terms employed herein. The definitions include various examples or forms of components that fall within the scope of a term and that may be used for implementation. The examples are not intended to be limiting. Both singular and plural forms of terms may be within the definitions.

“Data store” or “database,” as used herein, refers to a physical or logical entity that can store data. A data store may be, for example, a database, a table, a file, a list, a queue, a heap, a memory, a register, and so on. A data store may reside in one logical or physical entity or may be distributed between two or more logical or physical entities.

“Logic,” as used herein, includes but is not limited to hardware, firmware, software or combinations of each to perform a function(s) or an action(s), or to cause a function or action from another logic, method, or system. For example, based on a desired application or needs, logic may include a software-controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

“Signal,” as used herein, includes but is not limited to one or more electrical or optical signals, analog or digital signals, data, one or more computer or processor instructions, messages, a bit or bit stream, or other means that can be received, transmitted, or detected.

In the context of signals, an “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

To the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components. An “operable connection,” or a connection by which entities are “operably connected,” is one by which the operably connected entities or the operable connection perform its intended purpose. An operable connection may be a direct connection or an indirect connection in which an intermediate entity or entities cooperate or otherwise are part of the connection or are in between the operably connected entities.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (3D. Ed. 1995).

1. A method for uniquely identifying a light fixture for use in a positioning system, comprising:
providing a first set of LED and a second set of LED in the light fixture; and
controlling the first set of LED differently from the second set of LED such that a camera having the light fixture within its field of view captures images in which the first set of LED appears to emit light and the second set of LED appears to emit no light to form a detectable pattern uniquely associated with the light fixture.

2. The method of claim 1, the controlling including:
turning on the first set of LED in the light fixture or switching the first set of LED on and off at a non-capture threshold frequency or above, and, simultaneously, switching on and off the second set of LED in the light fixture at a switching frequency a) higher than a flicker threshold frequency below which human vision detects the switching but b) lower than the non-capture threshold frequency, the non-capture threshold frequency corresponding to a switching frequency at which the camera, due to the camera being set to predetermined frame rate and shutter speed, cannot capture images in which the first set of LED appears to emit light and the second set of LED appears to emit no light.

3. The method of claim 2, comprising:
switching a first group of LED from the second set of LED at a first switching frequency and a second group of LED from the second set of LED at a second switching frequency different from the first switching frequency such that the camera captures images in which the first group of LED appears to emit light and the second group of LED appears to emit no light to form a plurality of detectable patterns.

4. The method of claim 1, wherein a first portion of the second set of LED is designated as corresponding to a first symbol and a second portion of the second set of LED is designated as corresponding to a second symbol, the first symbol and the second symbol forming part of the detectable pattern uniquely associated with the light fixture.

5. The method of claim 4, wherein, within the first symbol, at least some LED in the first portion are sequentially swapped from the first set of LED to the second set of LED and back to achieve a substantially uniform light distribution.

6. The method of claim 1, comprising:
receiving data representing the images captured by the camera;
interpreting the images to decipher the detectable pattern; and
correlating the detectable pattern to the light fixture or to a location corresponding to the light fixture.

7. The method of claim 1, comprising:
receiving data representing a plurality of images captured by the camera including the images corresponding to the light fixture and images corresponding to other light fixtures;
interpreting the images to decipher the detectable pattern corresponding to the light fixture and detectable patterns corresponding to the other light fixtures;
correlating the detectable pattern corresponding to a location corresponding to the light fixture and correlating the detectable patterns corresponding to respective locations corresponding to the other light fixtures; and
triangulating the location corresponding to the light fixture and the locations corresponding to the other light fixtures to derive a position of the camera.

8. The method of claim 1, wherein the light fixture is a linear light fixture and the first set of LED includes LED disposed at ends of the linear light fixture such that detectable patterns such as the detectable pattern have a fixed frame and the second set of LED are disposed therebetween.

9. A positioning system, comprising:
a plurality of light fixtures;
a mobile device application configured to control a camera, set to predetermined frame rate and shutter speed, to capture images of one or more light fixtures from the plurality;
each of the light fixtures in the plurality including:
a first set of LED and a second set of LED non-overlapping with the first set of LED; and
a light fixture controller configured to control the first set of LED differently from the second set of LED such that the camera having the respective light fixture within its field of view captures images in which the first set of LED appears to emit light and the second set of LED appears to emit no light to form a detectable pattern uniquely associated with the respective light fixture;
a positioning system controller configured to:
receive data representing the images captured by the camera;
interpret the images to decipher one or more detectable patterns corresponding to the one or more light fixtures; and
correlate the one or more detectable patterns to the one or more light fixtures or to locations corresponding to the one or more light fixtures.

10. The positioning system of claim 9, wherein the light fixture controller is configured to control by turning on the first set of LED or switching the first set of LED on and off at a non-capture threshold frequency or above, and, simultaneously, switching on and off the second set of LED at a frequency a) higher than a flicker threshold frequency below which human vision detects the switching but b) lower than the non-capture threshold frequency, the non-capture threshold frequency corresponding to a switching frequency at which the camera, due to the camera being set to predetermined frame rate and shutter speed, cannot capture images in which the first set of LED appears to emit light and the second set of LED appears to emit no light.

11. The positioning system of claim 9, wherein the positioning system controller is further configured to triangulate the locations corresponding to the one or more light fixtures to derive a position of the camera.

12. The positioning system of claim 9, wherein a first section of LED from the second set of LED is designated as corresponding to a first symbol and a second section of LED from the second set of LED is designated as corresponding to a second symbol, the first symbol and the second symbol forming part of the detectable pattern uniquely associated with the respective light fixture, wherein the light fixture controller controls the LED to, within the first symbol, swap at least some LED in the first section from the first set of LED to the second set of LED and back to achieve a substantially uniform light distribution.

13. The positioning system of claim 9, wherein the light fixture is a linear light fixture and the first set of LED includes LED disposed at ends of the linear light fixture such that detectable patterns such as the detectable pattern have a fixed frame and the second set of LED are disposed therebetween.

14. A self-identifying light fixture for use in a positioning system, comprising:
a first set of LED and a second set of LED; and
a light fixture controller configured to control the first set of LED differently from the second set of LED such that a camera having the light fixture within its field of view captures images in which the first set of LED appears to emit light and the second set of LED appears to emit no light to form a detectable pattern uniquely associated with the light fixture.

15. The self-identifying light fixture of claim 14,
the light fixture configured to turn on the first set of LED or switch the first set of LED on and off at a non-capture threshold frequency or above, and, simultaneously, switch on and off the second set of LED at a switching frequency a) higher than a flicker threshold frequency below which human vision detects the switching but b) lower than the non-capture threshold frequency, the non-capture threshold frequency corresponding to a switching frequency at which the camera, due to the camera being set to predetermined frame rate and shutter speed, cannot capture images in which the first set of LED appears to emit light and the second set of LED appears to emit no light.

16. The self-identifying light fixture of claim 15, wherein switching on and off the second set of LED includes switching a first group of LED from the second set of LED at a first switching frequency and a second group of LED from the second set of LED at a second switching frequency different from the first switching frequency such that the camera captures images in which the first group of LED appears to emit light and the second group of LED appears to emit no light to form a plurality of detectable patterns.

17. The self-identifying light fixture of claim 14, wherein a first section of LED from the second set of LED is designated as corresponding to a first symbol and a second section of LED from the second set of LED is designated as corresponding to a second symbol, the first symbol and the second symbol forming part of the detectable pattern uniquely associated with the light fixture.

18. The self-identifying light fixture of claim 17, wherein, within the first symbol, at least some LED in the first section are sequentially swapped from the first set of LED to the second set of LED and back to achieve a substantially uniform light distribution.

19. The self-identifying light fixture of claim 14, wherein the light fixture is a linear light fixture and the first set of LED includes LED disposed at ends of the linear light fixture such that detectable patterns such as the detectable pattern have a fixed frame and the second set of LED are disposed therebetween.

20. The self-identifying light fixture of claim 14, wherein the first set of LED or the second set of LED are white light LED or infrared light LED.

21. The method of claim 1, the controlling including:
controlling the first set of LED differently from the second set of LED such that the camera having the light fixture within its field of view captures an image in which, simultaneously, a) the first set of LED appears to emit light and b) the second set of LED appears to emit no light, to form the detectable pattern uniquely associated with the light fixture.
